(19) United States
(12) Patent Application Publication
(10) Pub. No.: US 2002/0054840 A1
(43) Pub. Date: May 9, 2002

(54) PROCESS FOR THE UREA SYNTHESIS FROM AMMONIA AND CARBON DIOXIDE AND APPARATUS FOR CARRYING OUT THE PROCESS

(76) Inventor: VINCENZO LAGANA, MILANO (IT)

Correspondence Address: PETER A ABRUZZESE, KRAMER LEVIN NAFTALIS & FRANKEL, 919 THIRD AVENUE, NEW YORK, NY, 10022

(21) Appl. No.: 09/230,170

(22) PCT Filed: Jul. 22, 1997
(86) PCT No.: PCT/IT97/00180

(51) Int. Cl. B01J 8/04; B01J 8/02; C01C 1/00

(52) U.S. Cl. 422/191; 422/148; 422/190; 422/211; 422/234

(57) ABSTRACT

A urea synthesis process starting from ammonia and carbon dioxide carried out under a pressure of 120×10 2 to 400×10 2 KPa and a temperature of 140 to 215° C., in which the reaction takes place in a reactor in which gaseous CO 2 is fed in the bottom of the reactor while liquid ammonia and the recycled ammonium carbamate aqueous solution are fed from the top of the reactor, and going downward the reactor, they meet in countercurrent the rising gaseous CO 2.

### TECHNICAL FIELD

The present invention refers to a process for the urea manufacture using ammonia and carbon dioxide as starting materials. The invention refers also to a reactor particularly useful to carry out the process.

### BACKGROUND ART

It is known that the synthesis of urea from ammonia and carbon dioxide passes through the preparation of carbamate, it is therefore necessary to separate urea from the reaction mixture and to recycle the unreacted carbamate to the urea synthesis reactor.

Typically the urea synthesis reaction takes place with liquid ammonia and gaseous carbon dioxide in presence of a recycled carbamatc solution under a pressure ranging between 120×10² and 400×10² Kpa at a temperature in the range of 150 to 220° C. wherein reactants and recycled carbamate solution are concurrently injected from the bottom while urea together with carbamate and the excess reactants are recovered from the top of the reactor in order to be subsequently treated for the urea separation.

The processes wherein the reactants are fed concurrently to the reactor have several disadvantages all due to reduced reaction yield. As a matter of fact the density of the starting reaction mixture consisting of liquid ammonia, gaseous carbon dioxide and recycled carbamate solution, increases when going toward the top of the reactor because of the urea formation from liquid aunonia and gaseous carbon dioxide. Such a urea formation inhibits the reaction mixture from rising and promotes the establishing of a back-mixing which negatively affects the reaction yield. Moreover the reactant concentration reduction due to the urea formation does not promote the increase of the urea yield in the final reaction step. It has to be taken into account that CO₂ fed as a reactant contains a certain amount of inert gases that has to be removed. By a concurrent operation a gaseous phase saturated of CO₂ and NH₃ will be present all along the reactor; such a gaseous phase will reach the top of the reactor and the more is the CO₂ concentration the lower is the reaction efficiency since said CO₂ did not take part in the reaction.

### DISCLOSURE OF INVENTION

It has been now found, and this is the first object of the present invention, a process for the urea manufacture starting from CO₂ and NH₃, that does not exhibit the drawbacks of the above prior art processes. A further object of the present invention is a reactor that can be usefully employed in the process of the present invention. The objects of the present invention are attained with a urea synthesis process starting from ammonia and carbon dioxide carried out under a pressure of 120×10² to 400×10² KPa and a temperature of 140 to 215° C. in a reactor in which gaseous CO₂ is fed in the bottom of the reactor while liquid ammonia and recycled carbamate aqueous solution are fed from the top of the reactor, and going downward the reactor, they meet in countercurrent rising gaseous CO₂. Reactor behaviour is similar to the one of an adsorbing column. Preferably the reactor is equipped with means promoting a good contact between the going down liquid phase and the rising gaseous phase, said means consisting of filling-type materials or devices similar to distillation column trays. More preferably the liquid-vapour contact promoting means consist of essentially cylindrical shaped bottom open trays arranged along the reactor axis, said trays being provided with holes or opening in their side surfaces to allow the liquid to pass through, while upper base surface consisting of a net or perforated plate allows the gaseous CO₂ to go upward after having overcome the pressure of the descending liquid seal.

Liquid reactants consisting of ammonia and carbamate aqueous solution can be fed to the reaction through a single line in the upper part of the reactor or through separate lines. In the latter case carbamate is preferably fed at a lower level than liquid ammonia which is fed in the upper practicable part of the reactor.

The process according to the present invention in which the reaction takes place in a reactor in which the gaseous reactants are fed in countercurrent with respect to the liquid reactants has the following advantages over the conventional processes:

CO₂, being the lightest phase goes upward to the top of the reactor, whilst NH₃ and carbamate mixture, being the heaviest phase and having the tendency to increase its density because of the urea formation, goes downward to the bottom of the reactor; any risk to establishing the undesired back-mixing is therefore avoided;

The reaction takes always place in presence of an excess of either reactants, therefore increasing the relevant yield. As a matter of fact operating in countercurrent allows the reaction to takes place in the upper part of the reactor with an excess of ammonia; in the lower part of the reactor the reaction takes place with an excess of CO₂, which is the other reactant. Being the urea synthesis reaction an equilibrium reaction it is more shifted toward products as compared with same reaction taking place concurrently;

since as aforesaid CO₂ always contains a certain amount of inert gases, these latter accumulate in the upper part of the reactor wherefrom they should be removed and in order to increase the reaction yield, the inert gas concentration in CO₂ should be reduced to the lower level as possible. By operating in countercurrent, in the upper part of the reactor a liquid phase rich in NH₃ or even a liquid phase consisting of liquid NH₃ alone is present so that it is possible to obtain an ammonia saturated inert gas mixture where CO₂ is practically absent;

another advantage of the process according to the invention is that in the bottom of the reactor there is the maximum CO₂ concentration as well as the maximum pressure of the system promoting therefore its reaction with free ammonia still present in the solution, which is responsible of an increase of the solution temperature, again promoting urea synthesis reaction.

In order to better carry out the countercurrent process the reactor may be equipped with means which improve the close contact between descending liquid phase and rising gaseous phase. The reactor may be provided with internal device forcing liquid and gaseous phase to proceed through fixed routes; said devices could be filling-type materials or baffles.

### DETAILED DESCRIPTION OF THE INVENTION AND DRAWING

The invention will be better understood and its advantages will be apparent from the following description of particular embodiments of the invention itself with reference to the enclosed drawing; the description and drawing have not to be interpreted in any way as limiting the scope of the invention.

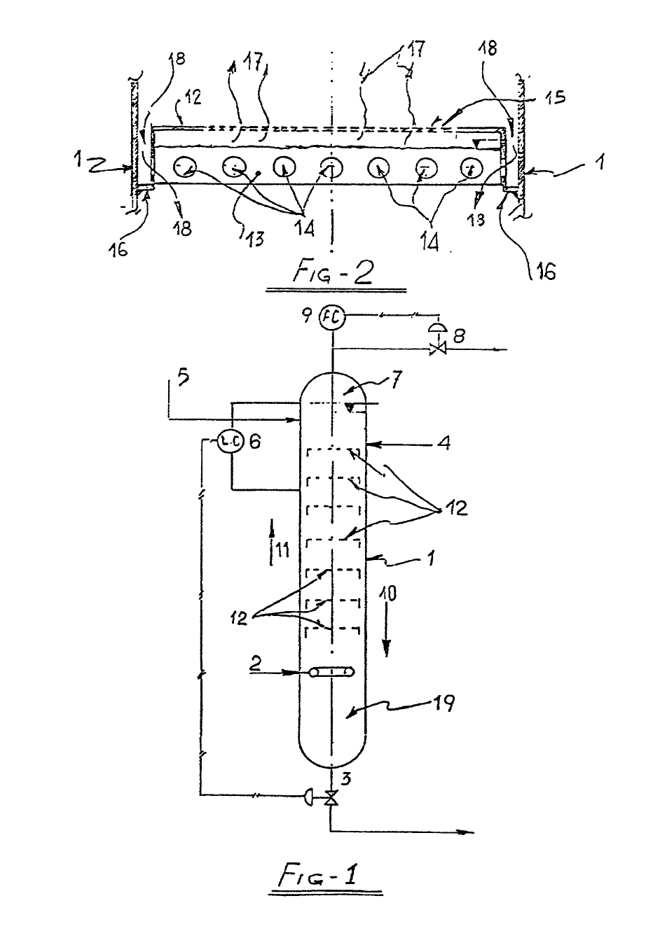

FIG. 1 is a reactor scheme useful to carry out the process according to the invention.

FIG. 2 represents in detail a preferred device to be placed inside of the reactor to improve the countercurrent operations of the process of the invention.

In FIG. 1 reactor 1 is comprised of a vertical column which may be operated under high pressure and at high temperature according to the practice of carrying out urea synthesis process. The pressure and temperature values may be respectively 120×10² to 140×10² KPa and 140 to 220° C. The reactor volume will be such as to allow a sufficient reaction time to perform the urea synthesis reaction. The reaction time may preferably be comprised between 15 and 90 minutes depending on the process operating conditions.

CO₂ which may include small amount of gases not taking part to the reaction, such as H₂, N₂, O₂, CH₄, CO, A, hereinafter referred to as inert gases, is fed to the lower part of the reactor 1 through line 2, at such a distance from the outlet of the obtained solution 3 as to allow this latter to get free from most therein dissolved gases and complete the urea formation reaction in the unperturbed zone 19 of the reactor bottom. In the upper portion of the reactor recycled carbamate solution is fed through line 4. At a higher level than line 4, liquid ammonia is fed through line 5 which is located at such a distance from the carbamate inlet line 4 as to allow liquid ammonia to adsorb most of CO₂ contained into the inert gases, so that a gas mixture is obtained which is practically free from CO₂. On the top of the reactor a level control device 6 is provided whose regulating valve acts on the urea solution coming out from the bottom of the reactor and maintains such a liquid level on top of the reactor as to keep the solution inside of the reactor for a sufficient residence time to form urea. The higher portion 7 of the reactor above the solution seal will be occupied by the mainly ammonia saturated inert gases that are removed from the liquid phase. Such a gaseous phase is vented out of the reactor through the pressure regulating valve 8 driven by the pressure control device 9 installed on top of the reactor 1 in order to keep the desired operating conditions.

Therefore the liquid entering the reactor through line 4 moves down by gravity in the direction of arrow 10 and ammonia fed through 5 starts reacting with the residual CO₂ moving toward the top of the reactor with inert gases in the direction of the arrow 11.

During the descent of the liquid along the reactor, urea formation starts, then free ammonia meets a continuous increasing CO₂ concentration and the heat of the reaction heats the solution promoting therefore the urea synthesis reaction.

Devices 12 are provided inside of the reactor improving the contact between moving down liquids and rising gases.

FIG. 2 illustrates a partial cross-section perspective view of a device particularly suitable to ensure the countercurrent carrying out of the process according to the invention in the reactor 1 of FIG. 1.

In FIG. 2 elements corresponding to the ones of FIG. 1 are identified by the same numeric reference. Hereinafter the device of FIG. 2 will be referred as “tray”.

As it appears from FIG. 2 a tray 12 of cylindrical shape has a base diameter which corresponds to 80 to 90% of the inner diameter of the reactor or column 1. The cylindrical tray height will be typically lower than the base diameter, but it will be at least 250 mm. Tray 12 is kept in its position by means of the plate 16 fixed to the inside wall of reactor or column 1. The cylindrical portion 13 of tray 12 is provided with a multiplicity of holes 14 where the moving down liquid phase passes through, while the gas phase pass through the perforated horizontal portion 15 of tray 12. The horizontal plate 15, being perforated or consisting of a suitably sized net, will improve the separation between the rising gas phase 17 and the descending liquid phase 18.

The gas phase reduced to small bubbles redisperses into the liquid phase laying on the tray 12 to continue moving upward, while the liquid phase descends through the space between the inner wall of the reactor and the peripheral edge of the tray and passing through the side holes goes down in the portion below the tray to continue its moving down.

### EXAMPLE

Data relating to the urea synthesis process according to the invention compared with data relating to a conventional concurrent urea synthesis process are reported hereinafter.

The following reactor operating conditions were identical in both cases.

Urea output 1000 t/d=41667 kg/h

Top reactor pressure=150×10² Kpa

Bottom reactor pressure=156×10² Kpa

Molar ratios NH₃/CO₂=3.5 H₂O/CO₂=0.6

In the above conditions the following results are obtained

| | CONCURRENT | | | | COUNTERCURRENT | | | |
|---|---|---|---|---|---|---|---|---|
| Exit temperature | 189° C. | | | | 192° C. | | | |
| Yield | 62.70% | | | | 67.89% | | | |
| Output composition | | | | | | | | |
| NH₃ | 42285 | kg/h | 33.40% | b.w. | 37257 | kg/h | 31.83% | b.w. |
| CO₂ | 18173 | kg/h | 14.36% | b.w. | 14455 | kg/h | 12.36% | b.w. |
| H₂O | 24461 | kg/h | 19.32% | b.w. | 23531 | kg/h | 20.16% | b.w. |
| UREA | 41667 | kg/h | 32.92% | b.w. | 41667 | kg/h | 35.69% | b.w. |
| Total | 126586 | kg/h | 100.00% | b.w. | 116927 | kg/h | 100.00% | b.w. |

carbamate recycled + NH₃

| | | | | | | | | |
|---|---|---|---|---|---|---|---|---|
| NH₃ | 65896 | kg/h | 68.62% | b.w. | 60868 | kg/h | 70.47% | b.w. |
| CO₂ | 18173 | kg/h | 18.62% | b.w. | 14455 | kg/h | 16.73% | b.w. |
| H₂O | 11961 | kg/h | 12.46% | b.w. | 11048 | kg/h | 12.80% | b.w. |
| Total | 96030 | kg/h | 100.00% | b.w. | 86371 | kg/h | 100.00% | b.w. |

As it appears from the above the countercurrent carried out process provides for a higher yield in that the solution coming out from the bottom of the reactor is subject to a higher pressure and it is in presence of a high CO₂ partial pressure which improves its reaction with residual liquid ammonia.

It is evident that such beneficial effect is not available in a process where all fluids are moving up toward the top of the reactor. Therefore it is important to stress that the higher yield obtained with the process and the apparatus according to the invention also implies the big advantage of a lower yield of carbamate to be recycled amounting in the above example to more than 10% providing for energy savings and a better overall economy of the process.

1. A urea synthesis process starting from ammonia and carbon dioxide carried out under a pressure of 120×10² to 400×10² KPa and a temperature of 140 to 215° C., characterised in that the reaction takes place in a reactor in which gaseous CO₂ is fed in the bottom of the reactor while liquid ammonia and the recycled ammonium carbamate aqueous solution are fed from the top of the reactor, and going downward the reactor, they meet in countercurrent the rising gaseous CO₂.

2. A urea synthesis process according to claim 1, characterised in that ammonia and the ammonium carbamate solution are fed separately to the reactor at different levels, ammonia being fed at a level higher than the carbamate solution.

3. Reactor useful to carry out the process according to claim 1, characterised in that it has the shape of a vertical column having an inlet (2) in its lower part for feeding gaseous carbon dioxide, possibly containing inert gases, an inlet (5) placed in the upper portion of the reactor for feeding ammonia and an inlet (4) for feeding ammonium carbamate solution, such inlet (4) being located in the upper part of the reactor, but at lower level with respect to the ammonia feeding inlet, an exit line (3) for the exit of the urea product and an exit (8) for inert gases, the reactor being equipped with means to ensure countercurrent contact between descending liquid phase and moving up carbon dioxide.

4. Reactor according to claim 3, characterised in that it is equipped with level control device (6) acting on the exit of urea solution from the bottom of the reactor in order to keep the liquid phase into the reactor for a sufficient time to complete the reaction.

5. Reactor according to claim 3 and 4, characterised in that the means ensuring the countercurrent contact are selected among reactor filling materials and baffles dividing the internal volume of the reactor.

6. Reactor according to claim 5, characterised in that the countercurrent contact promoting means consist of essentially cylindrical shaped bottom open trays (12) arranged along the reactor axis, said trays being provided with holes or opening in their side surfaces to allow the liquid to pass through, while the upper base surface consists of a net or perforated plate allowing gaseous CO₂ to go upward after having overcome the pressure of the descending liquid seal.
